(19) United States
(12) Patent Application Publication
(10) Pub. No.: US 2021/0363753 A1
(43) Pub. Date: Nov. 25, 2021

(54) PREFABRICATED WALL PANEL, MANUFACTURING METHOD AND STRUCTURAL SYSTEM

(71) Applicant: Carmine Franco VALENTE, Atina Inferiore, Frosinone (IT)

(72) Inventor: Carmine Franco VALENTE, Atina Inferiore, Frosinone (IT)

(21) Appl. No.: 17/286,615

(22) PCT Filed: Oct. 19, 2018
(86) PCT No.: PCT/IB2018/058161

§ 371 Date: Apr. 19, 2021

(51) Int. Cl. E04C 2/288; E04C 2/52; E04B 1/41; E04B 1/61; B32B 7/05; B32B 13/04; B32B 3/26; B32B 3/30; B32B 19/04; B32B 21/04; B32B 5/02

(52) U.S. Cl. CPC E04C 2/288; B32B 2262/108; E04B 1/41; E04B 1/612; B32B 7/05; B32B 13/04; B32B 3/266; B32B 3/30; B32B 19/04; B32B 21/04; B32B 5/02; E04B 2001/4192; E04B 2001/6195; B32B 2307/304; B32B 2307/102; B32B 2419/00; E04C 2/523

(57) ABSTRACT

A prefabricated wall panel defines a panel plane and a peripheral edge includes a plurality of material layers parallel to the panel plane and superimposed on one another, including a load-bearing layer made of reinforced cement, a protective layer distanced from the load-bearing layer, and a heat-insulating layer formed on a side of the load-bearing layer opposite to the protective layer. An air circulation gap is formed between two layers of the material layers so as to separate the two layers from each other. The air circulation gap is open on the entire peripheral edge. A plurality of spacer connectors extends in a direction transversal to the panel plane through the air circulation gap, each spacer connector having a first anchoring end fixed in the protective layer and a second anchoring end fixed in the load-bearing layer.

The present invention relates to a prefabricated wall panel and a structural system made with such panel, as well as a manufacturing method of the prefabricated panel.

In particular, the invention relates to a civil construction system, based on making and using prefabricated panels, composed of multiple layers, for making exterior and/or interior walls. The panel comprises multiple layers of different materials which simultaneously perform structural strength and/or anti-seismic, soundproofing and/or acoustic absorbing and heat-moisture protecting functions.

Multilayer wall panels are known, e.g. from CH69211A5, EP0921243A2, EP1273729A2, U.S. Pat. No. 6,625,948 B2, EP1892350A2. Furthermore, US2008/0022609A1 describes a mobile plant for prefabricating wall panels.

It is the object of the present invention to provide a prefabricated wall panel, a structural system comprising a plurality of wall panels and a method for prefabricating wall panels, having features so as to:

reduce construction time and costs, and/or

increase the heat-moisture protection performance of the wall panel and of the structural system casing, and/or

increase the versatility in the making of structural systems, in particular homes, with reference to size, number of stories and distribution of inner spaces, and/or

increase the standardization level of prefabrication and construction materials and equipment, and/or

facilitate the making of homes certified in compliance with seismic, sound and acoustic protection standards; and/or

increase the degree of industrialization and reduce the use of labor and lead times in the construction of homes, and/or

in a home, create one or two empty gaps adapted to guide an air flow from the outside towards the inside of the walls of the home, thereby eliminating moisture, foul air and gas, e.g. radon, which are the main cause of the lack of living comfort and deterioration of the structures of the known technique,

separate selected layers of the prefabricated panel or a wall of the structural system to form a gap inside them and thereby facilitate air circulation.

At least some of these objectives are achieved by means of a prefabricated wall panel according to claim 1. The dependent claims relate to advantageous and preferred embodiments.

According to an aspect of the invention, a prefabricated wall panel for making a structural system defines a panel plane and a peripheral edge and comprises:

A) a plurality of material layers parallel to the panel plane and superimposed on one another, comprising:
a load-bearing layer of reinforced cement,
a protective layer formed on an inner side of the load-bearing layer and distanced from the load-bearing layer,
a heat-insulating layer formed on an outer side of the load-bearing layer opposite to the inner side,
   B) an air circulation gap formed between two layers of said material layers so as to separate said two layers from each other, said air circulation gap being open on the entire peripheral edge,
   C) a plurality of spacer-connectors, e.g. made of metallic or synthetic material, extending in direction transversal to the panel plane through said air circulation gap and having a first anchoring end fixed in the protective layer and a second anchoring end fixed in the load-bearing layer.

The prefabricated panel is structurally supporting and resistant, soundproofing and heat-insulating, and allows a natural and continuous circulation of air inside the wall. Furthermore, the prefabricated panel can be easily manufactured by manufacturing in parallel a first semi-finished panel comprising the protective layer and a second semi-finished panel comprising the load-bearing layer, and subsequently overlapping and connecting the first and second semi-finished panels to each other.

In order to better understand the invention and appreciate its advantages, the description of some non-limiting embodiments will be provided below with reference to the figures, in which:

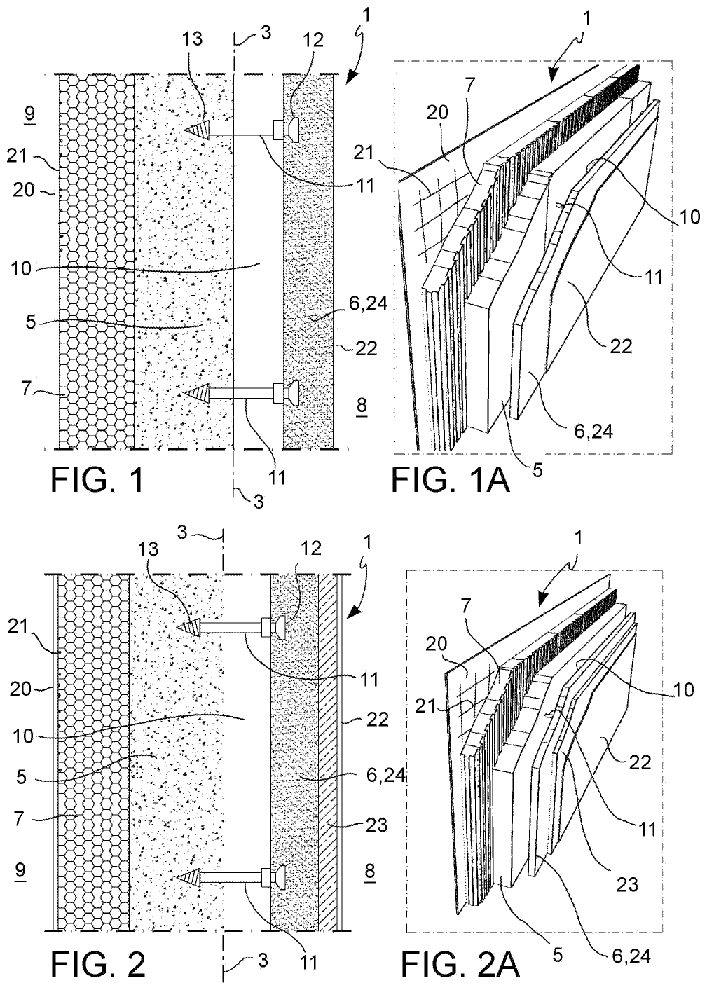

FIGS. 1 and 1A are cross-section and perspective views of a detail of a prefabricated wall panel according to a first embodiment.

FIGS. 2 and 2A are cross-section and perspective views of a detail of a prefabricated wall panel according to a second embodiment.

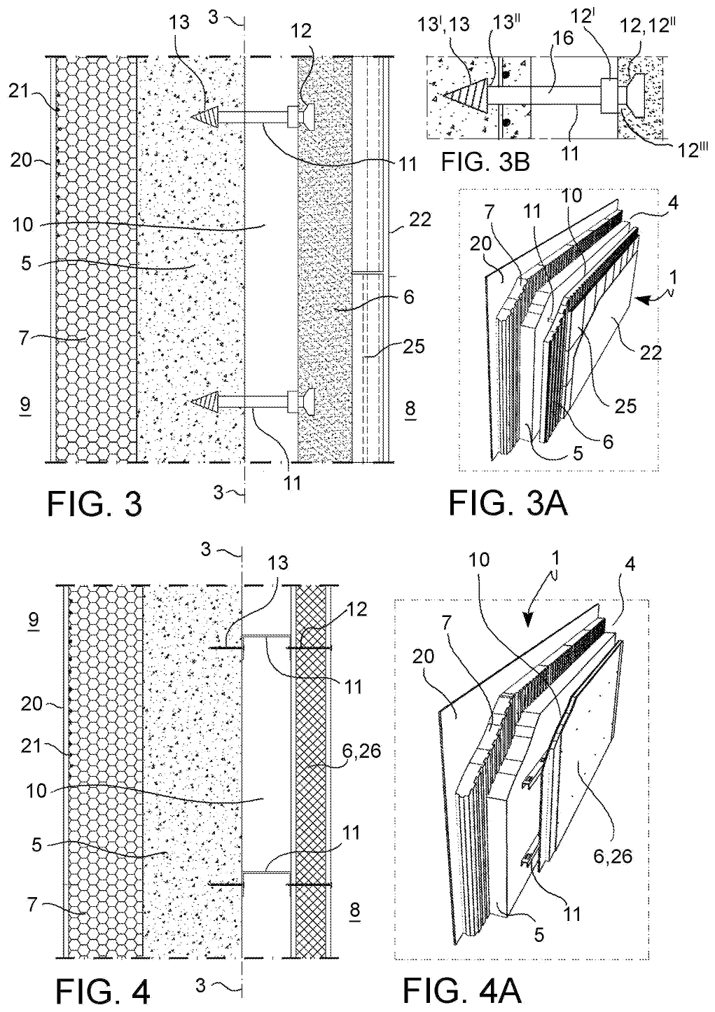

FIGS. 3 and 3A are cross-section and perspective views of a detail of a prefabricated wall panel according to a third embodiment.

FIG. 3B is a side view of a detail of the wall panel according to a further embodiment.

FIGS. 4 and 4A are cross-section and perspective views of a detail of a prefabricated wall panel according to a fourth embodiment.

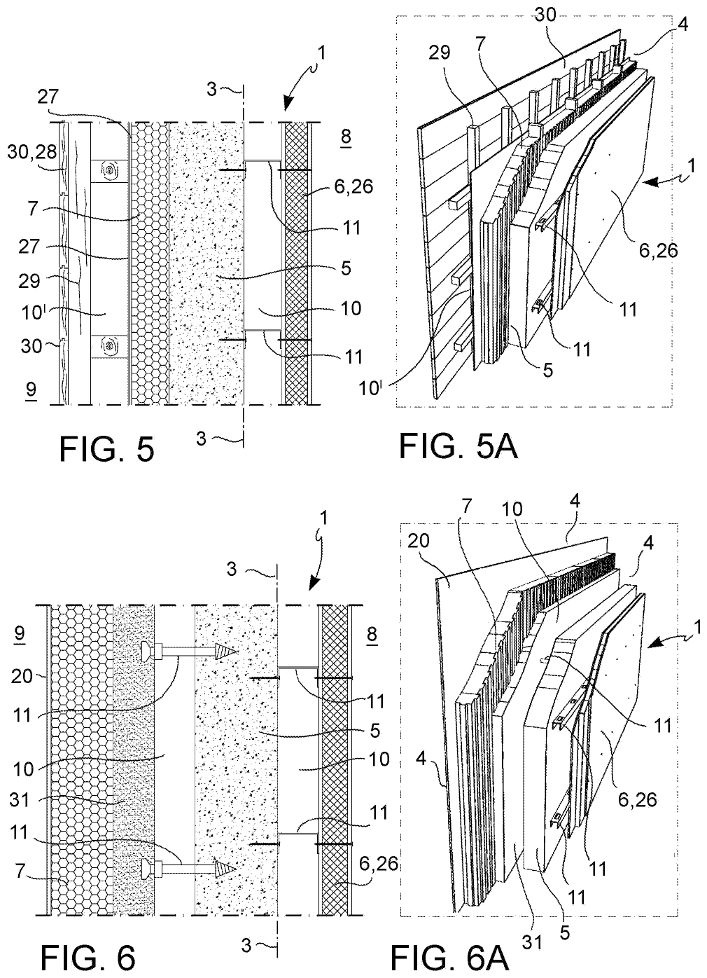

FIGS. 5 and 5A are cross-section and perspective views of a detail of a prefabricated wall panel according to a fifth embodiment.

FIGS. 6 and 6A are cross-section and perspective views of a detail of a prefabricated wall panel according to a sixth embodiment.

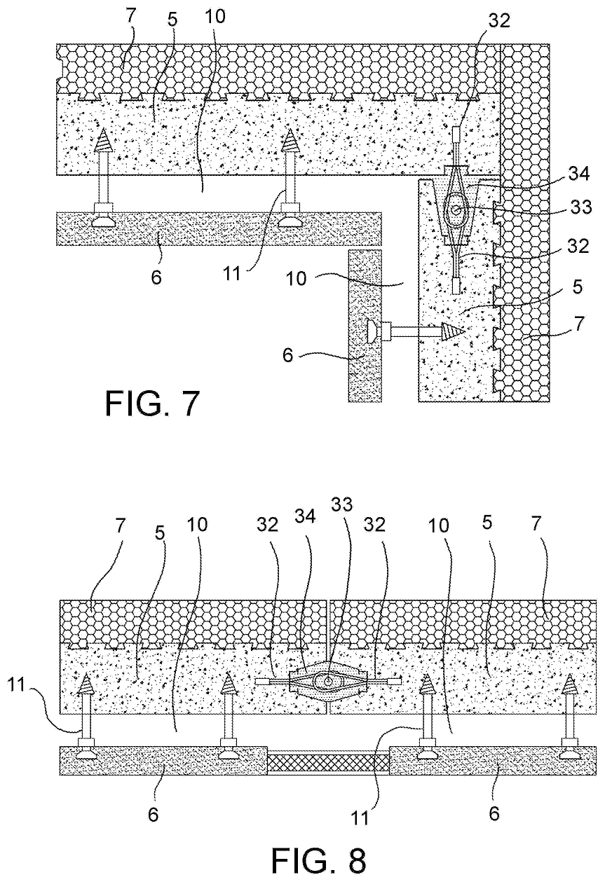

FIG. 7 is a horizontal cross-section view of a corner connection region of two walls or vertical panels of a structural system according to an embodiment.

FIG. 8 is a horizontal cross-section view of a planar connection region of two walls or vertical panels of a structural system according to an embodiment.

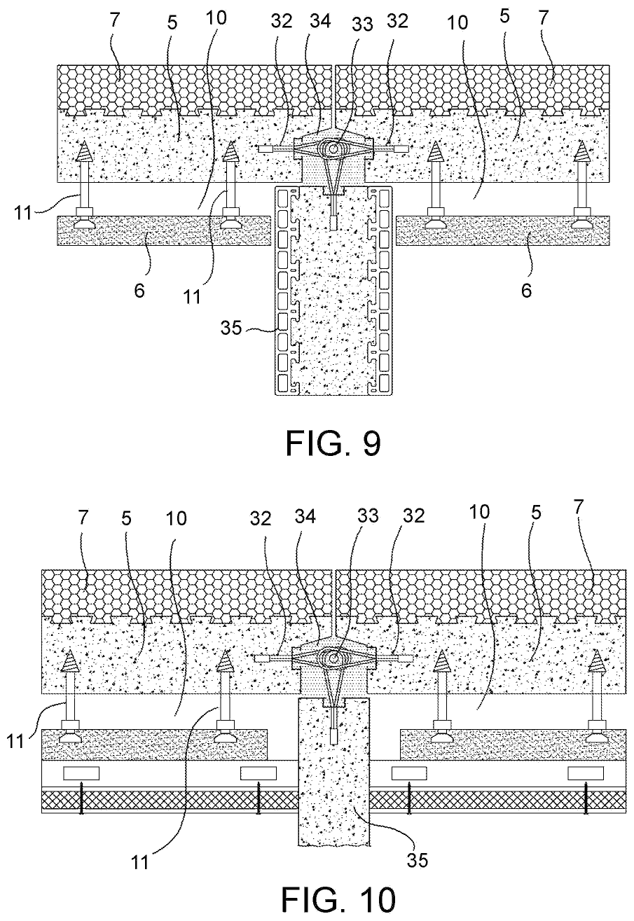

FIG. 9 is a horizontal cross-section view of a T connection region between an inner wall and two walls or vertical panels of a structural system according to an embodiment.

FIG. 10 is a horizontal cross-section view of a T connection region between an inner wall and two walls or vertical panels of a structural system according to a further embodiment.

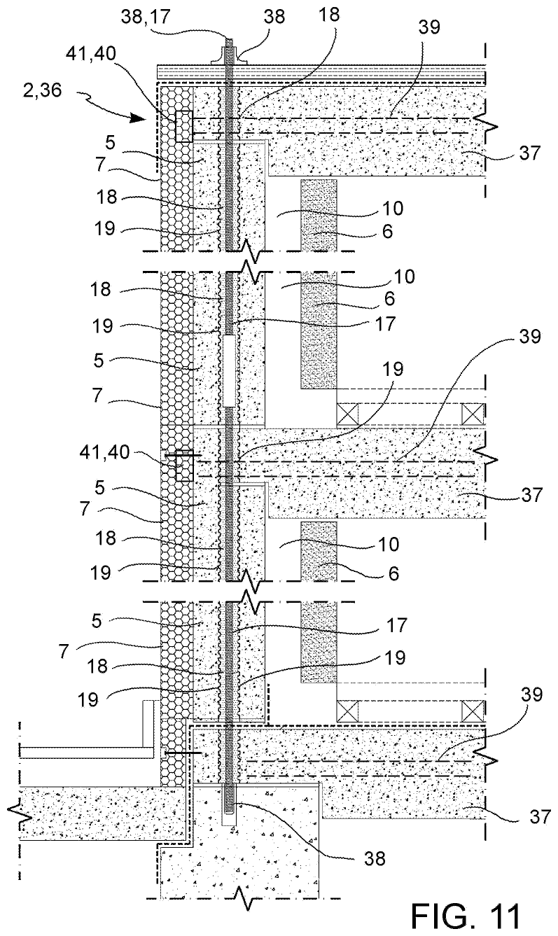

FIG. 11 is a vertical cross-section view of a region of a structural system comprising prefabricated panels according to an embodiment.

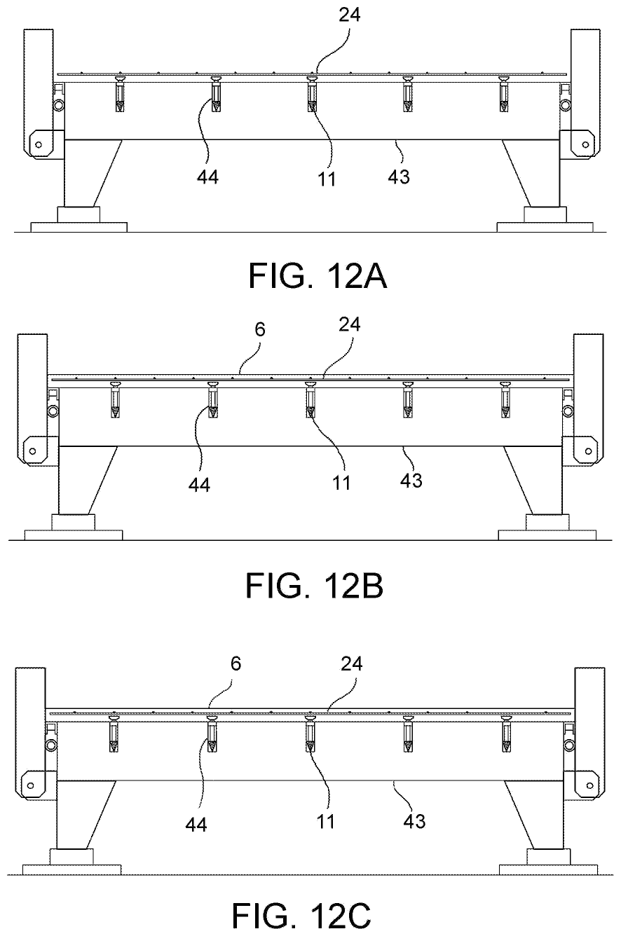

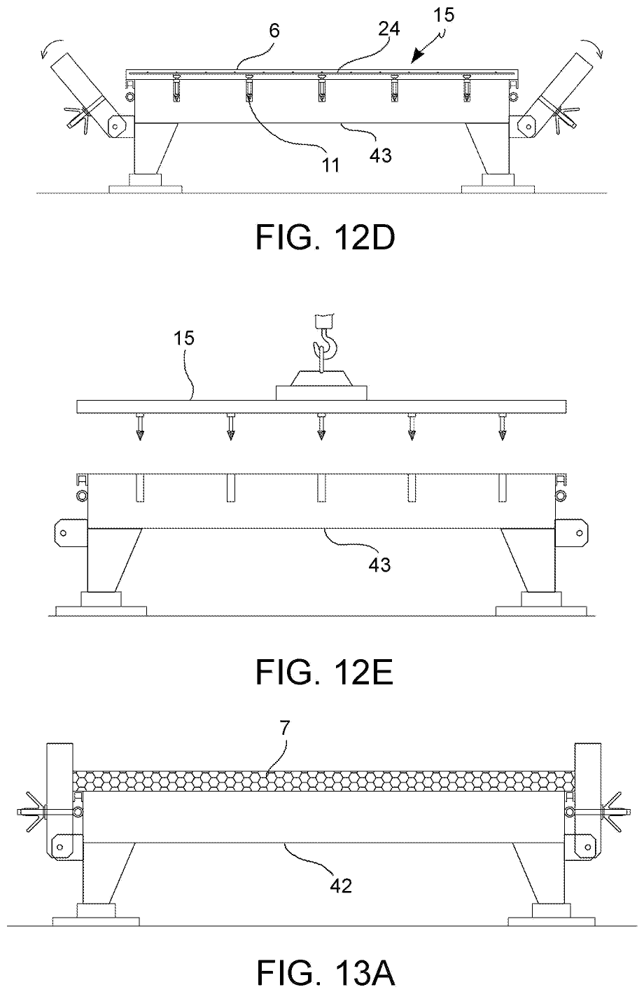

FIGS. 12A-12E illustrate a manufacturing and handling sequence of a second semi-finished panel, according to an embodiment.

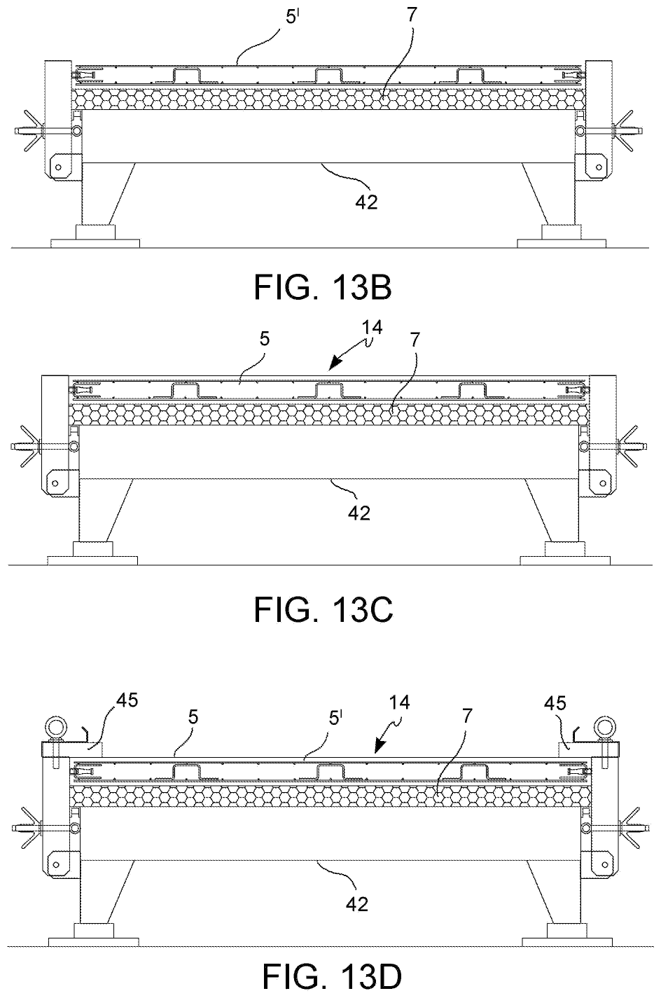

FIGS. 13A-13D illustrate a manufacturing and handling sequence of a first semi-finished panel, according to an embodiment.

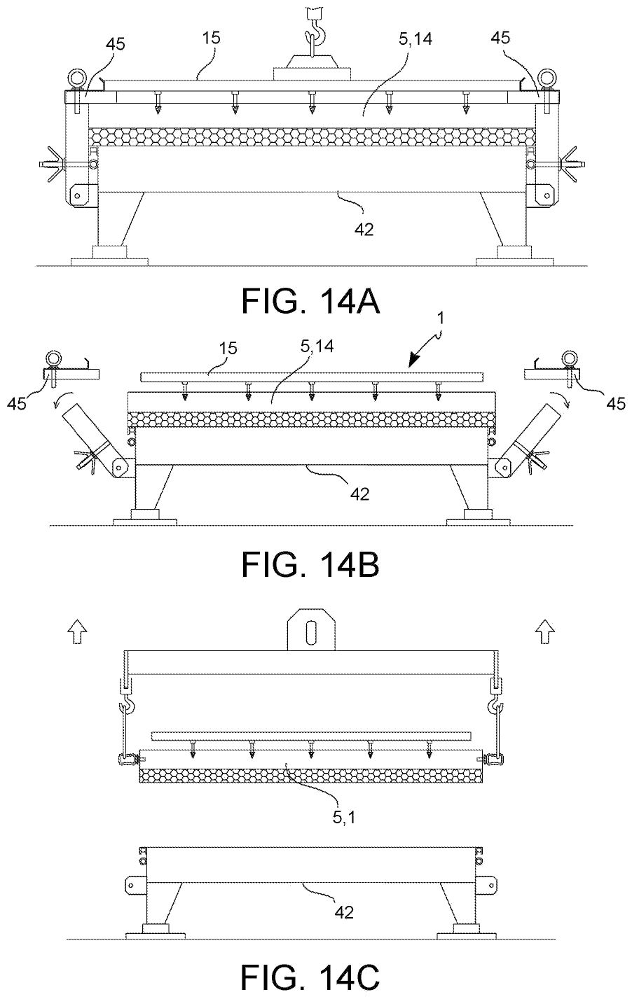

FIGS. 14A-14C illustrate a sequence of steps of joining between the first and second semi-finished panels to form a prefabricated panel, and subsequent handling of the prefabricated panel according to an embodiment.

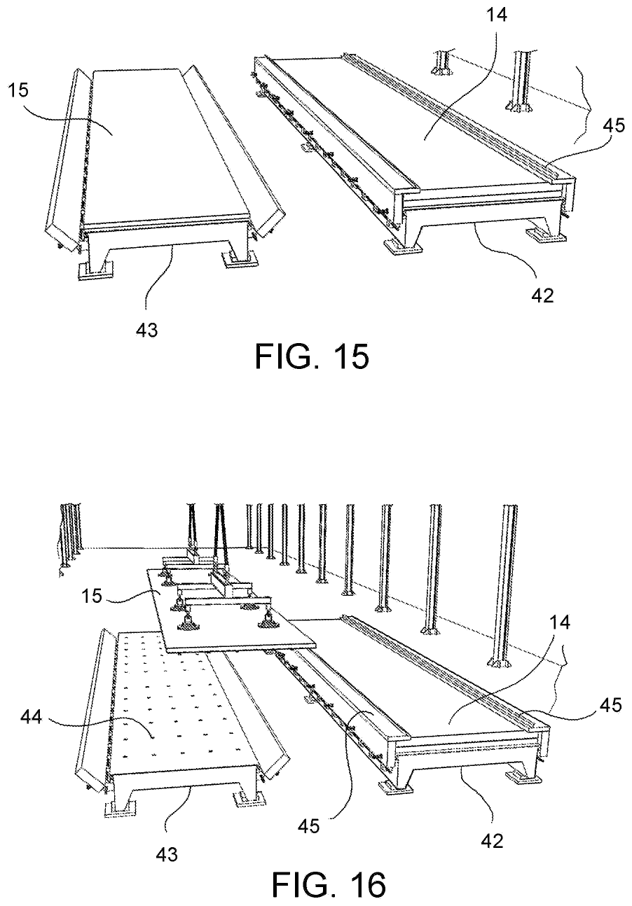

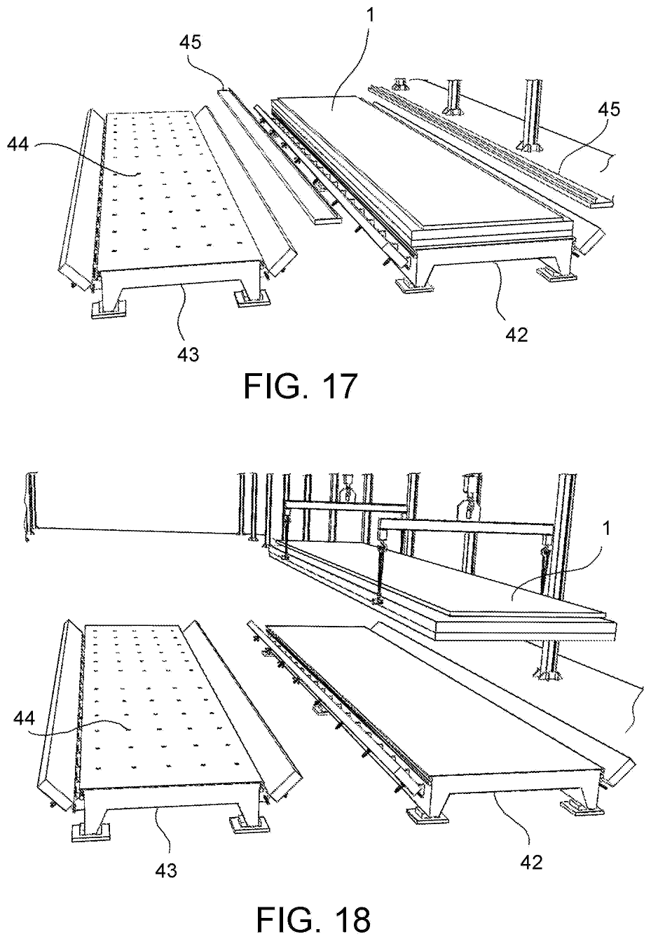

FIGS. 15-18 show the parallel execution of the steps of manufacturing of the semi-finished panels, illustrated in FIGS. 12A-12E and FIGS. 13A-13D.

### PREFABRICATED PANEL 1

With reference to the figures, a prefabricated wall panel 1 for making a structural system 2 for constructions, e.g. a building, defines a panel plane 3 and a peripheral edge 4 and comprises:

A) a plurality of material layers 5, 6, 7 parallel to the panel plane 3 and superimposed on one another, comprising:
a load-bearing layer 5 made of reinforced concrete,
a protective layer 6 formed on an inner side 8 of the load-bearing layer 5 and distanced from the load-bearing layer 5,
a heat-insulating layer 7 formed on an outer side 9 of the load-bearing layer 5 opposite to the inner side 8,
   B) an air circulation gap 10 formed between two layers 5, 6 of said material layers 5, 6, 7 so as to separate said two layers 5, 6 from each other, said air circulation gap 10 being open on the entire peripheral edge 4,
   C) a plurality of spacer-connectors 11, e.g. made of metal or synthetic material, extending in direction transversal to the panel plane 3 through said air circulation gap 10 and each having a first anchoring end 12 fixed in the protective layer 6 and a second anchoring end 13 fixed in the load-bearing layer 5.

The prefabricated panel 1 is structurally supporting and resistant, soundproofing and heat-insulating and allows a natural and continuous circulation of air inside the wall. Furthermore, the prefabricated panel 1 can be easily manufactured by manufacturing in parallel a first semi-finished panel 15 comprising the protective layer and spacer connectors 11 and a second semi-finished panel 14 comprising the load-bearing layer 5, and subsequently overlapping and connecting the first and second semi-finished panels to each other (FIGS. 12A-12E, 13A-13D, 14A-14C, 18-18).

The prefabricated panel 1 is preferably flat and plate-shaped with the peripheral edge generally in a regular polygonal shape, e.g. substantially rectangular or square.

According to an embodiment (FIG. 3B), the spacer-connector 11 is an elongated pin with a, e.g. cylindrical, central rod-shaped portion 16 extended between the first anchoring end 12 and the second anchoring end 13. The first anchoring end 12 comprises one or more annular flanges 12′, 12″ which mutually delimit an annular groove 12′″. A, preferably cylindrical, first flange 12″ is adapted and can be used to close a respective accommodation seat for the spacer connector 11 in a formwork for manufacturing the first semi-finished panel and, therefore, to avoid filling the accommodation seat for the spacer connector 11 with concrete or other cementitious material in a still liquid state. A second flange 12″, preferably truncated-cone and/or cylinder-shaped, is adapted to be surrounded by the material of the protective layer 6 in a still liquid or pasty state and to anchor the spacer-connector 12 in the material of the protective layer 6, e.g. reinforced concrete.

The second anchoring end 13 forms a, e.g. conical, pointed insertion portion 13′ which is connected by means of a step 13″ or barb to the central portion 16. The pointed insertion portion 13′ facilitates the penetration of the second anchoring end 13 from the outside into the still pasty or liquid cement of the load-bearing layer 5 and makes it possible to avoid a reinforcing reinforcement 5′ of the load-bearing layer 5. The step 13″ or barb allows an effective transmission of the anchoring forces from the second anchoring end 13 to the reinforcement 5′ of the load-bearing layer 5, in particular extracting forces of the spacer-connector 11.

According to an embodiment (FIG. 11), the reinforcing layer 5 comprises one or more tie-rod 18 holes, e.g. delimited by tubular sheaths 19, which are e.g. in metal, embedded in the cement of reinforcing layer 5. The tie-rod holes 18 are each adapted to receive a tie-rod 17, e.g. made of steel, which can be pretensioned so as to join and tighten a plurality of prefabricated panels 1 (or one or more prefabricated panels 1 and one or more other structural elements, e.g. floors) to one another and, possibly, pre-compressed with a desired degree of pre-compression. Advantageously, the tie-rod holes 18 are parallel to one another and parallel to the panel plane 3.

According to an embodiment (FIG. 1), heat-insulating layer 7 is directly adjacent to and in direct contact with the load-bearing layer 5 and is made of heat-insulating and soundproofing material, with a thickness in the range from 6 cm to 20 cm and, optionally, reinforced with plasticized net 21 or reinforceable with plasticized net 21 (on an outer side thereof opposite to the load-bearing layer 5) and adapted to receive one or more outer layers of colored plaster 20.

The load-bearing layer 5 is made of reinforced concrete, e.g. of thickness ranging from 18 cm to 24 cm, and performs a static and antiseismic bearing function. The air circulation gap 10 is directly delimited by the load-bearing layer 5 and by the protective layer 6.

The protective layer 6 (which can be seen as an inner wall of the home) comprises a reinforced concrete slab 24 (with reinforcement 24′) having a thickness smaller than the thickness of the load-bearing layer 5 and having a surface facing towards an inner side 8 of the prefabricated panel 1 and adapted to be painted or skimmed with indoor plaster 22. The air circulation gap 10 is fundamental for the circulation of air inside the prefabricated panel 1 and, therefore, the home which can be made.

According to an embodiment (FIG. 2), the protective layer 6 comprises a reinforced concrete slab 24 having a thickness smaller than the thickness of the load-bearing layer 5 and an additional acoustic absorption and/or soundproofing layer 23 with lesser density than the density of reinforced concrete slab 24, e.g. made of mineralized fibrous material. The latter acoustic absorption and/or soundproofing layer 23 is formed in direct contact with the reinforced concrete slab 24 on the opposite side of the load-bearing layer 5 and forms a surface facing towards an inner side 8 of the prefabricated panel 1 and adapted to be painted or skimmed with indoor plaster 22.

According to an embodiment (FIG. 3), the protective layer 6 comprises a reinforced concrete slab 24 having a thickness smaller than the thickness of the load-bearing layer 5 and an additional layer of brick elements 25 to increase the interior salubriousness of the environment, since they are made of clay. The latter layer of brick elements 25 is formed in direct contact with the reinforced concrete slab 24 on the opposite side of the load-bearing layer 5 and forms a surface facing towards an inner side 8 of the prefabricated panel 1 and adapted to be painted or skimmed with indoor plaster 22.

According to an embodiment (FIG. 4), the protective layer 6 either comprises (or is formed by) an inner panel 26 consisting of two plasterboard sheets with an intermediate auxiliary heat insulating layer, e.g. made of expanded polystyrene or mineralized rock wool. The thickness of the inner panel 26 may be in the range from 8 cm to 10 cm. The inner panel 26 forms a surface facing towards the inner side 8 of the prefabricated panel 1 and is adapted to be painted or skimmed with indoor plaster 22.

In this embodiment, the spacer-connectors 11 may comprise metal profiles, e.g. made of galvanized steel, e.g. “U”-shaped section bars anchored to both the load-bearing layer 5 and the protective layer 6, e.g. by means of screws or connectors which are already fixed when the concrete of load-bearing layer 5 is cast.

According to an embodiment (FIG. 5), the prefabricated panel 1 comprises four material layers made of four different materials and two air circulation gaps 10, 10′. The protective layer 6 either comprises (or is formed by) an inner panel 26 consisting of two plasterboard sheets with an interposed auxiliary heat insulating layer, e.g. made of expanded polystyrene. The thickness of the inner panel 26 may be in the range from 8 cm to 10 cm. The inner panel 26 forms a surface facing towards the inner side 8 of the prefabricated panel 1 and is adapted to be painted or skimmed with indoor plaster 22.

Also in this embodiment, the spacer-connectors 11 may comprise metal profiles, e.g. made of galvanized steel, e.g. “U”-shaped section bars anchored to both the load-bearing layer 5 and the protective layer 6, e.g. by means of screws or connectors which are already fixed when the concrete of load-bearing layer 5 is cast.

The heat-insulating layer 7 is directly adjacent to and in direct contact with load-bearing layer 5 and is made of heat insulating and soundproofing material, e.g. having a thickness in the range of 6 cm to 20 cm, with a moisture barrier layer 27 on the outer side 9 of the heat-insulating layer 7 opposite to the load-bearing layer 5. The moisture barrier layer 27 comprises, for example, aluminum paper.

The prefabricated panel 1 or the wall formed by a number of prefabricated panels 1 comprises a aesthetic outer wood layer 28, e.g. a vertical wooden framework 29 and a horizontal planking 30 formed by wooden slats with a minimum thickness of 3 cm. The aesthetic wood layer 28 is spaced from the heat-insulating layer 7, forming a second air gap 10′ between them, by means of autoclaved wooden beams fixed to the load-bearing layer 5 and placed, e.g. horizontally.

According to an embodiment (FIG. 6), the prefabricated panel 1 comprises four material layers made of four different materials and two air circulation gaps 10, 10′. The protective layer 6 either comprises (or is formed by) an inner panel 26 consisting of two plasterboard sheets with an interposed auxiliary heat insulating layer, e.g. made of expanded polystyrene. The thickness of the inner panel 26 may be comprised in the range from 8 cm to 10 cm. The inner panel 26 forms a surface facing towards the inner side 8 of the prefabricated panel 1 and is adapted to be painted or skimmed with indoor plaster 22.

Also in this embodiment, the spacer-connectors 11 may comprise metal profiles, e.g. made of galvanized steel, e.g. “U”-shaped section bars anchored to both the load-bearing layer 5 and the protective layer 6, e.g. by means of screws or connectors which are already fixed when the concrete of load-bearing layer 5 is cast.

The heat-insulating layer 7 is spaced from the load-bearing layer 5 and comprises a layer of heat-insulating and soundproofing material, e.g. of thickness in the range from 10 cm to 20 cm, and a reinforced concrete supporting layer 31, facing towards the load-bearing layer 5 and distanced from it, forming therebetween a second ventilation gap 10′, by means of a plurality of the aforesaid spacer-connectors, e.g. spacers 11 in the form of pins, as described in FIG. 3B.

Structural System 2

Figures from 7 to 11 show examples of embodiments of details of the structural system 2, in particular of a residential building, made using the above described prefabricated panels 1.

FIG. 7 shows a corner structural node formed by two prefabricated panels 1, in which connecting reinforcements 32 protruding from each of the two prefabricated panels 1 are engaged by means of a vertical steel bar 33, which is consolidated after assembly using an integrative concrete casting 34. The air circulation gap 10 continuously extends from a prefabricated panel 1 to the adjacent prefabricated panel/s 1 thereby promoting air circulation. The heat-insulating layer 6 is also continuous and has no heat bridges.

FIG. 8 shows a linear structural node formed by two prefabricated panels 1, in which connecting reinforcements 32 protruding from each of the two prefabricated panels 1 are engaged by means of a vertical steel bar 33, which is consolidated after assembly using an integrative concrete casting 34. The air circulation gap 10 continuously extends from a prefabricated panel 1 to the adjacent prefabricated panel/s 1 thereby promoting air circulation. The heat-insulating layer 6 is also continuous and has no heat bridges.

FIG. 9 shows a “T”-shaped structural node joining two prefabricated panels 1 of a same wall plane, as well as an inner partition wall panel 35, e.g. made of concrete and brick or concrete (FIG. 10). The connecting reinforcements 32 protruding from each of the two prefabricated panels 1 are engaged by means of a vertical steel bar 33, which is consolidated after assembly with an integrative concrete casting 34. The air circulation gap 10 continuously extends from a prefabricated panel 1 to the adjacent prefabricated panel/s 1 or through ventilation holes formed in the end of the partition wall panel 35 at the air circulation gaps 10 of the prefabricated panel/s 1. The heat-insulating layer 6 is continuous and has no heat bridges.

FIG. 11 shows a number of prefabricated panels 1 oriented and arranged one above the other on a vertical wall plane (possibly alternated with interposed floor elements 37) to form a vertical wall 36, as well as one or more tie-rods 17.

The tie-rods 17 are anchored to the vertical wall 36 at their anchoring ends 38 and extend parallel to the panel plane 3 through the load-bearing layer 5 of the prefabricated panels 1 and, possibly, through end portions (edges) of the floor elements 37 respectively interposed between two vertically adjacent prefabricated panels 1, and can be locked and/or tensioned or pretensioned, e.g. by means of a tensioning nut 38 screwed onto the threaded end of the tie-rod 17 and resting against the vertical wall 36, so as to hold it together.

The tie-rods 17 may comprise one or more steel ropes or steel rods threaded at the ends and having a length substantially corresponding to wall height 36. The diameter of the tie-rod 17 is chosen according to the required tensile strength, preferably equal to or greater than 24 mm.

In addition to the one or more vertical walls 36, the structural system 2 may also comprise one or more horizontal walls 37 connected to the vertical walls 36, as well as a number of horizontal tie-rods 39 anchored to the vertical wall 36 or to the horizontal wall 37 at their anchoring ends 40 and extending horizontally through the horizontal wall 37 and which may be locked and/or clamped or pretensioned, e.g. by means of a tensioning nut 41 screwed onto the threaded end of horizontal tie-rods 39 and resting against the horizontal wall 37, so as to hold the structural system 2 together horizontally.

### Manufacturing Method

According to an embodiment, the prefabricated panel 1 is made by means of the steps of:

manufacturing a first semi-finished panel 15 comprising the protective layer 6 and the spacer connectors 11 protruding from the protective layer 6, wherein the second anchoring ends 13 form free ends of the spacer connectors 11 (FIGS. 12A-12E),

manufacturing a second semi-finished panel 14 comprising the load-bearing layer 5, wherein the cement of the load-bearing layer 5 is not yet solidified and faces upwards (13A-13D),

overlapping the first semi-finished panel 15 from above, with the spacer connectors 11 protruding downwards, on the second semi-finished panel 14 and immersing the second anchoring ends 13 into the cement of the load-bearing layer 5 not yet solidified, keeping a clear distance between the protective layer 6 and the load-bearing layer 5 (FIGS. 14A-14B),

making the cement of the load-bearing layer 5 solidify (FIGS. 14B-14C).

According to an advantageous embodiment, the method comprises:

manufacturing the first semi-finished panel 15 in a first formwork 43 of a first manufacturing line, said first formwork 43 having a bottom wall with a plurality of connector seats 44 adapted to accommodate the spacer connectors 11 with the first anchoring ends 12 protruding at least partially out of the bottom wall,

manufacturing the second semi-finished panel 14 in a second formwork 42 of a second manufacturing line. This is done advantageously after the first semi-finished panel 15 has been manufactured, preferably the next day,

lifting the first semi-finished panel 15 out of the first formwork 43 and lowering it onto the second formwork 42 containing the second semi-finished panel 14 with the cement of the load-bearing layer 5 not yet solidified,

during the immersion of the second anchoring ends 13 into the cement of the load-bearing layer 5 which has not yet solidified, placing the protective layer 6 of the first semi-finished panel 15 on a spacer device 45 (movable or removable) of the second formwork 42 which keeps said clear distance between the protective layer 6 and the load-bearing layer 5,

after the cement in the load-bearing layer 5 has solidified, lifting the prefabricated panel 1 out from the second formwork 42.

By way of example, it took 2.67 hours to make experimental models of the prefabricated panel 1, e.g. to produce the panel in FIG. 1, with a surface area of 25.13 m², while it took 3.25 hours to make the one in FIG. 6 having the same surface area.

The prefabricated panel 1 and the structural system 2, as well as the manufacturing method described hereto, are economically viable, combine the advantages of traditional and industrialized building constructions and improve construction quality and living comfort.

A person skilled in art can made further changes and variants all contained within the scope of protection defined by the claims in order to satisfy contingent, specific needs.

1. A prefabricated wall panel for making a structural system for constructions, wherein said prefabricated wall panel defines a panel plane and a peripheral edge and comprises:
A) a plurality of material layers parallel to the panel plane and superimposed on one another, comprising:
a load-bearing layer made of reinforced concrete,
a protective layer formed on an inner side of the load-bearing layer and distanced from the load-bearing layer, and
a heat-insulating layer formed on an outer side of the load-bearing layer opposite to the inner side,
B) an air circulation gap formed between two layers of said plurality of material layers to separate said two layers from each other, said air circulation gap being open on the entire peripheral edge, and
C) a plurality of spacer-connectors extending in a direction transversal to the panel plane through said air circulation gap, each spacer-connector of said plurality of spacer-connectors comprising a first anchoring end fixed in the protective layer and a second anchoring end fixed in the load-bearing layer.

2. The prefabricated wall panel of claim 1, wherein:
each spacer-connector forms an elongated central portion extending between the first anchoring end and the second anchoring end,
the first anchoring end comprises one or more annular flanges delimiting an annular step or groove, and
the second anchoring end forms a pointed insertion portion connected by a step or barb to the elongated central portion.

3. The prefabricated wall panel of claim 1, wherein the load-bearing layer comprises one or more tie-rod holes, defined by tubular sheaths positioned in the load-bearing layer, each tie-rod hole being adapted to receive a tie-rod to join and tighten the prefabricated wall panel either to a further prefabricated panel or to one or more further structural elements.

4. The prefabricated wall panel of claim 3, wherein the tie-rod holes are parallel to one another and parallel to the panel plane.

5. The prefabricated wall panel of claim 1, wherein:
the heat-insulating layer is in direct contact with the load-bearing layer and is made of heat-insulating and soundproofing material, of thickness ranging from 6 cm to 20 cm,
the load-bearing layer is made of reinforced concrete of thickness ranging from 18 cm to 24 cm,
the air circulation gap is directly delimited by the load-bearing layer and by the protective layer, and
the protective layer comprises a reinforced concrete slab having a thickness smaller than the thickness of the load-bearing layer and having a surface facing towards the inner side of the prefabricated wall panel.

6. The prefabricated wall panel of claim 5, wherein the protective layer comprises a soundproofing layer of density lower than the density of the reinforced concrete slab or made of mineralized fibrous material, said soundproofing layer being formed in direct contact with the reinforced concrete slab on a side opposite to the load-bearing layer.

7. The prefabricated wall panel of claim 5, wherein the protective layer comprises a layer of brick elements formed in direct contact with the reinforced concrete slab on the side opposite to the load-bearing layer.

8. The prefabricated wall panel claim 1, wherein:
the protective layer comprises a panel consisting of two plasterboard sheets with an auxiliary heat-insulating or expanded polystyrene layer between the two plasterboard sheets.

9. The prefabricated wall panel of claim 1, wherein the prefabricated wall panel comprises four material layers in four different materials and two air circulation gaps separated by at least one of the four material layers.

10. The prefabricated wall panel of claim 1, wherein the heat-insulating layer is in direct contact with the load-bearing layer and covered by a moisture barrier layer, or by aluminum paper, positioned on the outer side of the heat-insulating layer opposite to the load-bearing layer.

11. The prefabricated wall panel of claim 1, comprising an outer aesthetic wood layer spaced apart from the heat-insulating layer, and a second air circulation gap between the outer aesthetic wood layer and the heat-insulating layer.

12. The prefabricated wall panel of claim 1, wherein the heat-insulating layer is spaced apart from the load-bearing layer and comprises a layer of heat-insulating material and a support layer made of reinforced concrete facing the load-bearing layer and spaced from the load-bearing layer so as to form one of the air circulation gaps between the layer of heat-insulating material and the support layer.

13. A structural system of a residential building, comprising prefabricated wall panels for making a structural system for constructions, wherein said prefabricated wall panel defines a panel plane and a peripheral edge and comprises:
A) a plurality of material layers parallel to the panel plane and superimposed on one another, comprising:
a load-bearing layer made of reinforced concrete,
a protective layer formed on an inner side of the load-bearing layer and spaced apart from the load-bearing layer, and
a heat-insulating layer formed on an outer side of the load-bearing layer opposite to the inner side,
B) an air circulation gap formed between two layers of said plurality of material layers to separate said two layers from each other, said air circulation gap being open on the entire peripheral edge, and
C) a plurality of spacer-connectors extending in direction transversal to the panel plane through said air circulation gap, each spacer-connector of said plurality of spacer-connectors comprising a first anchoring end fixed in the protective layer and a second anchoring end fixed in the load-bearing layer,
wherein connecting reinforcements protruding from two adjacent prefabricated wall panels are respectively engaged by a vertical steel bar consolidated by an additional concrete casting, wherein the air circulation gap continuously extends from a prefabricated wall panel to a respective adjacent prefabricated wall panel.

14. The structural system of claim 13, comprising:
a plurality of said prefabricated wall panels oriented and arranged one above the other on a vertical wall plane to form a vertical wall, wherein the load-bearing layer comprises one or more tie-rod holes, defined by tubular sheaths positioned in the load-bearing layer, each tie-rod hole being adapted to receive a tie-rod to join and tighten the prefabricated wall panel either to a further of said prefabricated panels or to one or more further structural elements, and
tie-rods anchored to the vertical wall at the anchoring ends and extending parallel to the panel plane through the load-bearing layer of the prefabricated wall panels and tightened to keep the prefabricated wall panels structurally united.

15. The structural system of claim 14, wherein the tie-rods also extend by floor elements interposed between respectively two vertically adjacent prefabricated wall panels.

16. The structural system of claim 13, comprising horizontal walls connected to vertical walls, and horizontal tie-rods anchored to the vertical wall or the horizontal wall at the anchoring ends and extending horizontally through the horizontal wall and tightened so as to hold the structural system joined horizontally.

17. A method for making a prefabricated panel for making a structural system for constructions, wherein said prefabricated wall panel defines a panel plane and a peripheral edge and comprises:
A) a plurality of material layers parallel to the panel plane and superimposed on one another, comprising:
a load-bearing layer made of reinforced concrete,
a protective layer formed on an inner side of the load-bearing layer and distanced from the load-bearing layer, and
a heat-insulating layer formed on an outer side of the load-bearing layer opposite to the inner side,
B) an air circulation gap formed between two layers of said plurality of material layers to separate said two layers from each other, said air circulation gap being open on the entire peripheral edge, and
C) a plurality of spacer-connectors extending in a direction transversal to the panel plane through said air circulation gap, each spacer-connector of said plurality of spacer-connectors comprising a first anchoring end fixed in the protective layer and a second anchoring end fixed in the load-bearing layer,
said method comprising the steps of:
manufacturing a first semi-finished panel comprising the protective layer and the spacer connectors protruding from the protective layer, wherein the second anchoring ends form free ends of the spacer connectors,
manufacturing a second semi-finished panel comprising the load-bearing layer, wherein cement of the load-bearing layer faces upwards and has not yet solidified,
overlapping the first semi-finished panel from above, with the spacer connectors protruding downwards, on the second semi-finished panel and immersing the second anchoring ends into the cement of the load-bearing layer not yet solidified, but keeping a clear distance between the protective layer and the load-bearing layer, and
solidifying the cement in the load-bearing layer.

18. The method of claim 17, further comprising:
manufacturing the first semi-finished panel in a first formwork, said first formwork having a bottom wall with a plurality of connector seats,
placing the spacer connectors in the connector seats with the first anchoring ends protruding at least partially from the bottom wall,
placing a reinforcement on the bottom wall and applying a cement casting onto the bottom wall so that the cement surrounds the reinforcement and at least part of the first anchoring ends of the spacer connectors,
manufacturing the second semi-finished panel in a second formwork,
lifting the first semi-finished panel out of the first formwork and lowering the first semi-finished panel onto the second formwork containing the second semi-finished panel with the cement of the load-bearing layer not yet solidified,
during immersion of the second anchoring ends into the cement of the load-bearing layer not yet solidified, placing the protective layer of the first semi-finished panel on a spacer device of the second formwork which keeps said clear distance between the protective layer and the load-bearing layer, and
after the cement in the load-bearing layer has solidified, lifting the prefabricated wall panel out from the second formwork.
